(19) United States
(12) Patent Application Publication
(10) Pub. No.: US 2010/0112997 A1
(43) Pub. Date: May 6, 2010

(54) LOCAL TRIGGERING METHODS, SUCH AS APPLICATIONS FOR DEVICE-INITIATED DIAGNOSTIC OR CONFIGURATION MANAGEMENT

(75) Inventor: Brian Roundtree, Kirkland, WA (US)

Correspondence Address: PERKINS COIE LLP;PATENT-SEA, P.O. BOX 1247, SEATTLE, WA, 98111-1247, US

(73) Assignee: Nuance Communications, Inc., Burlington, MA (US)

(21) Appl. No.: 12/446,221

(22) PCT Filed: Aug. 16, 2007
(86) PCT No.: PCT/US07/76154

§ 371 Date: Jan. 6, 2010

(51) Int. Cl. H04M 3/00

(52) U.S. Cl. 455/420

(57) ABSTRACT

A system and method of performing device-initiated diagnostic or configuration management on a mobile device. In some examples, the system identifies a problem related to of the mobile device, communicates with a remote server on a network a message pertaining to the problem, initiates a remedial action at the server, and changes the configuration of the mobile device based on the remedial action. In some cases, the system may transmit a message to the server that triggers the action to be performed. In some cases, the system may not require a user to understand how to solve the problem.

### CROSS-REFERENCE TO RELATED APPLICATION(S)

This application claims the benefit of U.S. Provisional Patent Application No. 60/838,215, filed on Aug. 16, 2006, entitled LOCAL TRIGGERING METHODS, SUCH AS APPLICATIONS FOR DEVICE INITIATED DEVICE MANAGEMENT, incorporated by reference in its entirety.

### BACKGROUND

Current methods of correcting device configuration problems or other issues related to use and operation of a mobile device (e.g., a cellphone) require a manual effort from either a user of the mobile device or another associated party, such as a customer service agent. For, example, in order to fix a configuration setting on a mobile device, a user may have to log onto their carrier's website, select appropriate options, and attempt to reconfigure and fix the settings. However, the user may not understand the problem or be able to effectively articulate to a customer service agent the problem and other related information. These and other problems exist with respect to assisting users of mobile devices.

### BRIEF DESCRIPTION OF THE DRAWINGS

FIG. 1 is a schematic diagram illustrating a mobile device on which device-initiated diagnostic or configuration management can be implemented.

FIG. 2A is a schematic diagram illustrating a system architecture for implementing diagnostic or configuration management methods.

FIG. 2B is a schematic diagram illustrating a component architecture for implementing diagnostic or configuration management methods at a remote server.

FIG. 3 is a schematic diagram illustrating a system architecture for the network-based diagnostic or configuration management and the mobile device of FIG. 2.

FIG. 4 is a schematic diagram illustrating the software architecture for the mobile device of FIG. 1.

FIG. 5 is a flow diagram illustrating a routine for diagnostic or configuration management of a mobile device.

FIG. 6 is a flow diagram illustrating a routine for triggering a device management action.

### DETAILED DESCRIPTION

A method and system for device-initiated diagnostic or configuration management of a mobile device is disclosed. In some examples, the system employs applications on the mobile device to identify configuration settings and/or problems. Identified configuration settings and/or problems are communicated to a server at a location remote from the mobile device, and fixes or updates to the configuration of the mobile device are transmitted from the server to the mobile device. For example, the system may send a message (e.g., a message previously established and stored within the mobile device) to the server upon identifying a configuration error. The message causes an action to be performed at the remote server, such as triggering the remote server to transmit settings information to the mobile device. The system updates the configuration of the mobile device to reflect the received settings information.

The system will now be described with respect to various embodiments and examples. The following description provides specific details for a thorough understanding of, and enabling description for, these embodiments of the system. However, one skilled in the art will understand that the system may be practiced without many of these details. In other instances, well-known structures and functions have not been shown or described in detail to avoid unnecessarily obscuring the description of the embodiments of the system.

It is intended that the terminology used in the description presented below be interpreted in its broadest reasonable manner, even though it is being used in conjunction with a detailed description of certain specific embodiments of the system. Certain terms may even be emphasized below; however, any terminology intended to be interpreted in any restricted manner will be overtly and specifically defined as such in this Detailed Description section.

### Suitable System

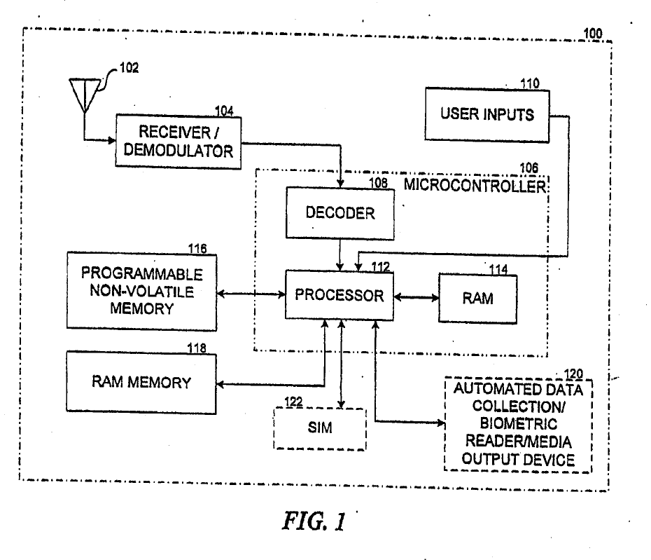

FIG. 1 illustrates a mobile device 100 on which the device-initiated diagnostic or configuration management system can be implemented in accordance with several embodiments of the system. A receiver/demodulator 104 receives a transmitted signal via an antenna 102 and reconstructs the original transmitted signal. The transmitted signal is sent to a microcontroller 106, which consists of a decoder 108, a processor 112, and RAM (Random Access Memory) 114. The decoder 108 translates the signals into meaningful data and interfaces to other devices. Decoded data, along with subscriber inputs 110, are sent to the processor 112. In addition, the mobile device may include optional components, such as an automated data collection 120 unit linked to the processor 112, which can include an automated RFID (Radio Frequency Identification) tag reader, a magnetic card swipe reader, a bar code reader, and others. Additionally, or alternatively, the mobile device may include a biometric reader (e.g., thumbprint reader, voice fingerprint recognition functionality, etc.), and/or a media output device (e.g., MP3 player, television tuner/player, etc.) 120. The mobile device may also include a subscriber identity module (SIM) 122. The output of the processor 112 can be stored in a programmable non-volatile memory 116 or in the RAM memory 118.

Additionally, the subscriber identity module, or SIM card, may contain any or all of the processing components, memory components or storage components described herein. To that end, the device may perform SIM card based processing, memory, or storage.

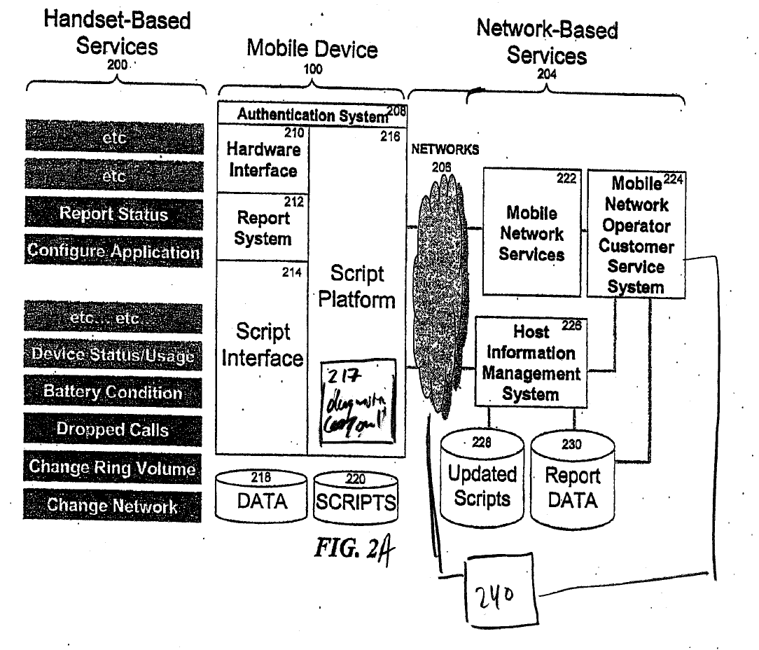

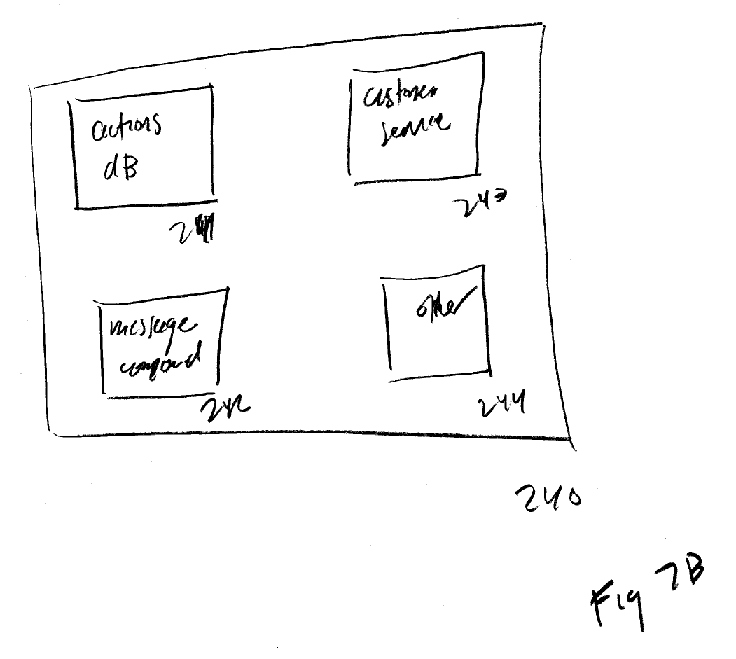

FIG. 2A illustrates a system architecture for implementing device-initiated diagnostic or configuration management methods. The system architecture includes three components: handset-based services 200, the mobile device 100, and network-based services 204. FIG. 1 and the discussion herein provide a brief, general description of a suitable telecommunications or computing environment in which the system can be implemented. Although not required, aspects of the system are described in the general context of computer-executable instructions, such as routines executed by a general-purpose computer, e.g., mobile device, a server computer, or personal computer. Those skilled in the relevant art will appreciate that the system can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In other embodiments, the mobile device or portable device may represent the server portion, while the server may represent the client portion.

The handset-based services 200 may include executable software, software configurations, hardware configurations and controls, and handset operating system interfaces. As disclosed herein, executable software may include, without limitation, any software program stored on the mobile device or associated memory device, both permanently and temporarily connected via hardware or wireless connectivity. The mobile device 100 may include an authentication system 208 (e.g., via a SIM), a hardware interface 210, a report system 212, a script interface 214, a script platform 216, data 218, scripts 220, and a device management component 217. The network-based services and/or components 204 may include a network or networks 206, mobile network services 222, a mobile network operator customer service system 224, a host information management system 226, updated scripts 228, report data 230 and device management component 240. The components of the mobile device 100 and the network-based services 204 will be described below.

The components within the mobile device 100 allow the device to integrate both handset-based services 200 and network-based services 204. The authentication system 208 can implement SIM (Subscriber Identity Module) card-based or standalone authentication to meet network requirements for desired levels of security. Authenticating a system to meet network requirements may not be required but is often recommended.

The hardware interface 210 may retrieve hardware interface elements required for interfacing with network or phone-based customer support services. Examples of hardware interface elements include changing volume, changing frequency, retrieving SIM (Subscriber Identity Module) ID, connection status from the SIM or radio hardware, and others. The report system 212 may collect and forward the data reported by the mobile device to the network 206. The report system 212 can also encrypt the handset identification information to provide increased security. The information can be encoded so that only the host information management system 226 can decipher the handset identification information.

The script interface 214 serves as a standard application programming interface for customer support services. More specifically, the script interface 214 provides an interface between scripts 220 and the various hardware-specific and executable, program-specific functions. The script interface 214 allows a single customer service script to be deployed across multiple operating systems and hardware configurations. In addition, the script interface 214 includes a standard API (Application Programming Interface) for both the hardware/OS side and the script interface.

The script platform 216 can mix and match calls through the script interface to acquire information, to change or correct settings on the phone, and to perform additional functions as described below. The script platform 216 authenticates, runs, and updates all scripts 220, manages reporting updates and changes, communicates with the host information management system 226, communicates with the GUI (Graphical User Interface), and manages customer surveys and interviews. The host information management system 226 can push a notification to the script platform 216 via USSD (Unstructured Supplementary Services Data), SMS (Short Message Service), IP (Internet Protocol), or any other network connectivity that the mobile device supports. The script platform 216 can run the scripts 220 after authentication, and the scripts 220 can be authenticated to the network 206 or to the phone.

The components within the network-based services 204 allow the mobile device 100 to communicate with and to retrieve data from the network 206. The network-based services 204 may include wired and wireless systems. The mobile network services 222 may consist of one or more systems including billing, CRM (Customer Relationship Management), provisioning, and others. Furthermore, mobile network services 222 are able to return data calls made by mobile devices via standard network protocols (e.g., IP, DTMF (Dual-Tone Multi-Frequency), SMS, USSD, etc.).

The mobile network operator customer service system 224 may also consist of one or more systems relating to customer service, including billing, CRM, provisioning, and others. The host information management system 226 controls interactions between the mobile device and the host customer support system. The host information management system 226 can transmit updates to the mobile device. The mobile device typically employs a unique handset ID or serial number, and a mobile phone number. The report data 230 provides storage for report information gathered from the mobile device. The updated scripts 228 consist of scripts that the host customer support system provides to the mobile device. The updated scripts 228 can be managed and versioned as desired by the host information management system 226, can be targeted at specific subscribers or groups of subscribers, and can include requests for reports and customer interview surveys.

The device management component 240 may communicate with the mobile device 100, such as via a diagnostic component within the script platform 216. FIG. 2B illustrates a component architecture for implementing diagnostic management methods as network-based services 204. The device management component 240 includes an actions database 241 that contains one or more actionable scripts, a message component 242 capable of receiving messages from the mobile device 100, translating or identifying data from within the messages, and transmitting messages back to the mobile device 100. The component 240 may also include a customer service component 243 that interacts with other customer service functions provided by the network based services 204. For example, the customer service component 243 may request information from the mobile network operator customer service system 224, or may provide information to system 224. The component 240 may include other additional components or modules 244, such as components that contain user specific or device specific data, components that contain configuration updates and settings, and so on.

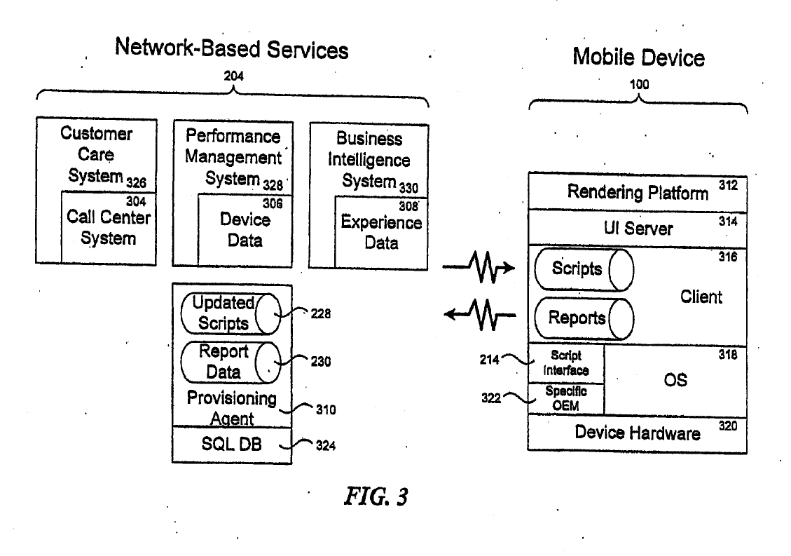

FIG. 3 illustrates a system architecture for the network-based services 204 and the mobile device 100. The network-based services 204 include a call center system 304, device data 306, subscriber experience data 308, and a provisioning agent 310. The call center system 304 may be part of a customer care system 326, the device data 306 may be part of a performance management system 328, and the subscriber experience data 308 may be part of a business intelligence system 330. The call center system 304 can manage settings remotely and can collect data OTA (over the air) from the mobile device 100 without asking the subscriber for permission. The call center system 304 can also automatically collect device data (e.g., handset ID and mobile phone number) 306 and subscriber experience data (e.g., the nature of the customer service problems) 308 from the mobile device 100. The device data 306 and the subscriber experience data 308 may be integrated into network-based services or used standalone.

The provisioning agent 310 interacts with the updated scripts 228 and report data 230. The provisioning agent collects report data 230 associated with the device data 306 and subscriber experience data 308 from the mobile device 100. The provisioning agent also corrects subscriber problems in real-time by transmitting appropriate scripts to the mobile device 100. The transmission of scripts to, and the collection of data from, the mobile device 100 may be hosted within the network or externally. In addition, the updated scripts 228 and the report data 306 may be stored in an SQL (Structured Query Language) database 324.

The mobile device 100 may include a rendering platform 312 (e.g., implemented in C++), an optional UI (User Interface) server 314, a client 316, and a script interface 214. The client 316 generates reports containing subscriber data and transmits the reports to the network-based services 204. The client 316 receives scripts 320 from the network-based services 204 that can correct subscriber problems. The script interface 214 allows a single script to be executed by multiple operating systems and hardware configurations. In addition, the mobile device 100 may also include an OS (Operating System) 318, specific OEM (Original Equipment Manufacturer) 322, and device hardware 320. In general, the mobile device scripts or applications may be customized via a European Computer Manufacture's Association (ECMA) compliant scripting language such as JavaScript. Such software can be installed by the manufacturer, or after manufacturing, such as over the air, particularly with open OS-based devices. For proprietary OS-based devices, a small kernel can be installed at the time of manufacturing or flashed onto the device at a later time, and then the full client application can be installed on the mobile device over the air.

As explained herein, the scripts or software applications on the mobile device provide for at least the following processes: providing customer care to a subscriber on the mobile device by intercepting calls; diagnostic tools to allow customer service representatives to remotely execute diagnostics and commands on the mobile device or to facilitate diagnostics with other equipment, with proactive tool to correct problems for subscribers on the mobile device; collecting and summarizing data and other metrics with respect to mobile devices; and, guides to train subscribers when they need it most, such as the first time they attempt to use an application, identifying and triggering device management functions, such as configuration updates or corrections, settings implementations, application implementations, and so on. Further details with respect to possible scripts or software applications may be found in commonly-assigned co-pending U.S. patent application Ser. No. 11/063,663, filed on Feb. 22, 2005, entitled CALL INTERCEPT METHODS, SUCH AS FOR CUSTOMER SELF-SUPPORT ON A MOBILE DEVICE, and PCT Application No. PCT/US06/24637 filed on Jun. 23, 2006, entitled LOCAL INTERCEPT METHODS, SUCH AS APPLICATION FOR PROVIDING CUSTOMER ASSISTANCE FOR INFORMATION CALLS AND DIAGNOSTICS, which are incorporated by reference in their entirety.

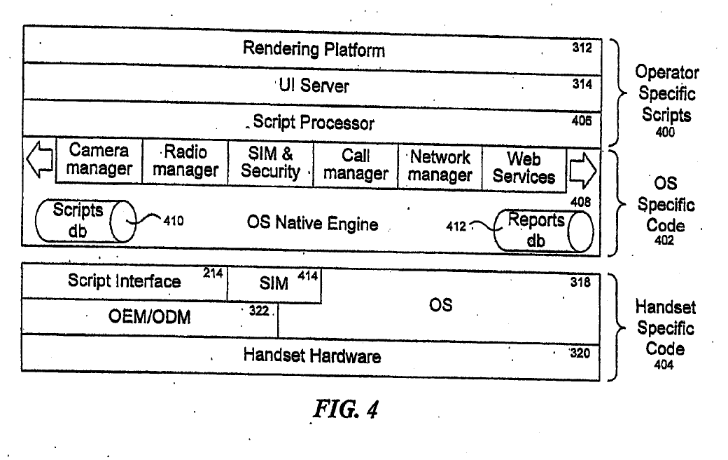

FIG. 4 illustrates the architecture for the mobile device 100. The rendering platform 312, the UI server 314, and a script processor 406 handle or are involved in handling operator specific scripts 400. Operator specific scripts 400 may include scripts pertaining to billing information, bill payment, forwarding calls, setting up an online photo album, and others, including those specific to a wireless service provider (such as those providing a preferred user interface). The OS native engine 408, which includes a scripts database 410 and a reports database 412, utilizes OS specific code 402. The script interface 214 utilizes handset specific code 404. Handset specific code 404 may also be applied to a SIM 414, an OS 318, specific OEM 322, and handset hardware 320.

### System and Method for Device Initiated Diagnostic Management

As described herein, the mobile device includes one or more scripts that locally perform diagnostic or configuration management on the device to gather data regarding the configuration, operation, and/or functionality of the device. The scripts may be loaded to the mobile device when the mobile device is fabricated, or may be loaded over the air (OTA), (such as when initiated from a call center agent desktop computer). The scripts may be automatically initiated by the mobile device, manually initiated by a user of the mobile device, and/or remotely initiated by a customer care agent. The diagnostic or configuration scripts are launched on the mobile device to resolve problems encountered by the user. In some cases, the diagnostic or configuration scripts may be proactively launched when other scripts or applications are running on the device. For example, the scripts can be included within already running applications, such as the customer care applications and/or tutorial/guide applications discussed herein and in the related applications. The mobile device collects, via the running applications, data or information that can be used to proactively resolve possible configuration problems or errors. For example, the system uses the scripts to monitor the device, such as to monitor the configuration of the device. The scripts, which may reside within the memory of the device, within the SIM of the device, and so on, may initiate, trigger and/or launch device-management functions or actions that assist in correcting problems or updating settings or functions of the device.

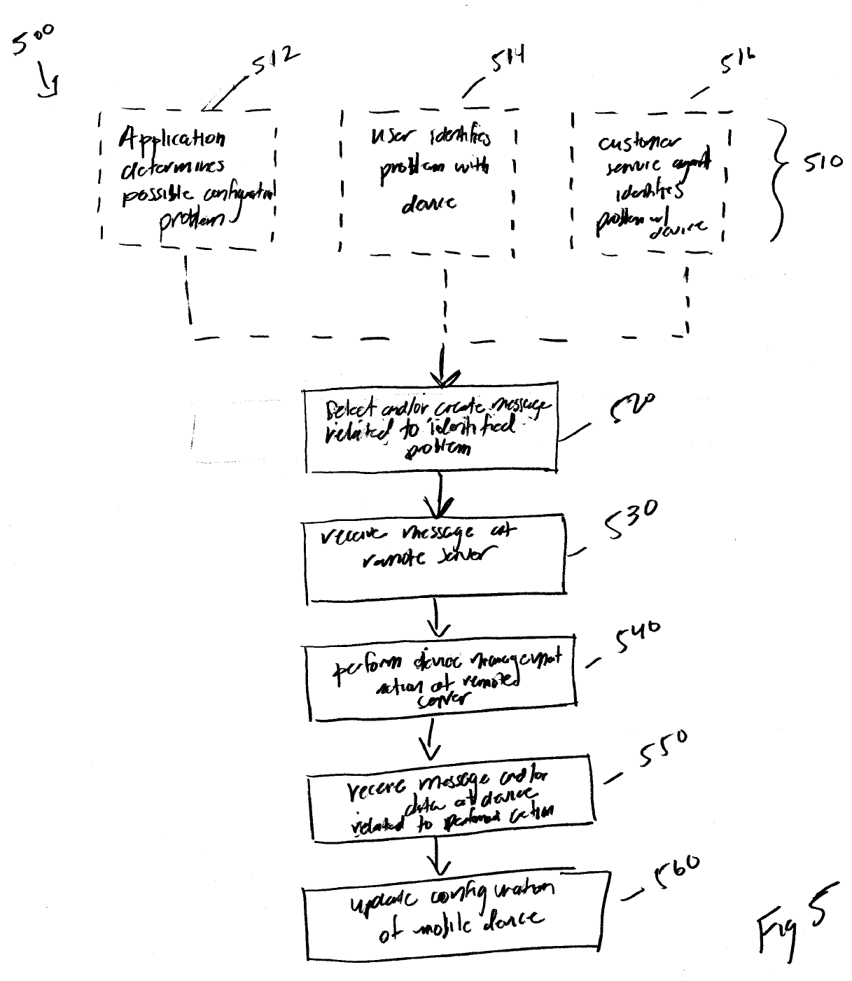

Referring to FIG. 5, a flow diagram illustrating a routine 500 for diagnostic or configuration management of a mobile device is described. In step 510, a problem is identified on the mobile device. The problem may be an error in the configuration of the mobile device, a lack of updated settings or profile information within the mobile device, a need for additional applications to be loaded onto the mobile device, a user desire for an updated or changed configuration of the mobile device, and so on. A problem does not necessarily cause the mobile device to perform undesirably or incorrectly, and may simply relate to the impetus of a request from the device or a user of the device to alter and/or modify the configuration of the mobile device in some way.

There are many ways in which the system identifies a problem with the mobile device. For example, in step 512, a running application identifies a problem with the configuration of the mobile device. The running application may be a guide application providing a tutorial to a user of available services and functions provided by the device or may be a customer care application that acts to diagnose help requests initiated by a user by intercepting calls and/or messages to a customer care center. The running application can automatically identify the configuration of the mobile device without input from a user or customer care agent.

A user may also identify a problem with the mobile device, as shown in step 514. For example, when the user attempts to connect to a wireless network and is unsuccessful, the system may present a number of options to be selected by the user that define a possible problem. The system presents, via a graphical user interface or via a audio user interface, one or more choices that describe the problem faced by the user. In this example, the user interface may present options such as “Are you having a problem connecting to the internet?” or “Are you having a problem connecting to a wireless network?” Based on receiving input from the user about an encountered problem, the system can diagnose and/or determine any configuration errors or problems without relying on the user to attempt to solve the problem his or herself.

A customer service agent may also identify a problem with the mobile device, as shown in step 516. For example, a user may call a customer service center related to a provider of services for the user when the user encounters a problem. The customer service agent, upon receiving information from the user or from the mobile device (such as during an over the air diagnosis of the mobile device), may then be able to identify a problem with the device.

Once a problem is identified, the system, in step 520, selects and/or creates a message to be sent to a device management server. The system may employ a variety of message protocols. Examples include an SMS (full number or short code) that can be sent to a predefined recipient, such as an open mobile alliance device management (OMA DM) server, a message or sent data over an http(/s) connection or other connection over the Internet. For example, using http or https, the mobile device may access a mobile operator's website, enter a user's account information and other information related to an identified problem. Also, the system may use a USSD interface (such as a USSD control channel) to send messages to the DM server.

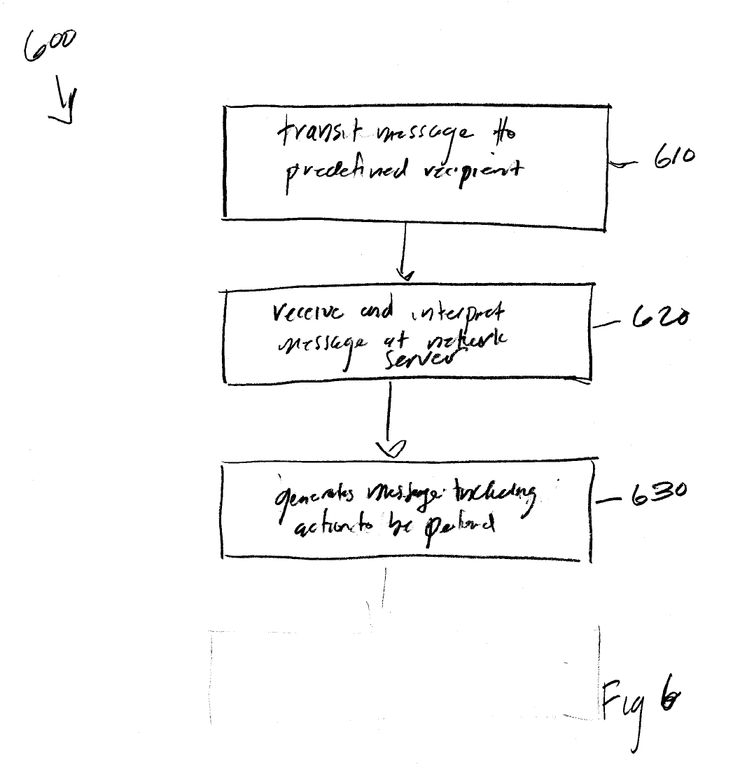

In step 530, the device management server receives the message from the mobile device. Depending on the type of the message, the server may translate the message, or may route the message to an appropriate location for further processing. In step 540, the system performs a device management action at the remote server. Some examples of device management actions include provisioning of new applications, provisioning of application upgrades (such as upgrades required to fix bugs, to fix security flaws, to add new features, and so on), personalization and customization of a mobile device, monitoring a device, repairing a device, and so on. For example, the system creates a message to be sent back to the mobile device that includes a configuration file used to fix a security flaw in the mobile device. Further details regarding how and when received messages trigger device management actions will be described with respect to FIG. 6 below. A message is then sent from the device management server back to the mobile device. In step 550, the mobile device receives the message from the device management server, and, in step 560, updates the configuration of the mobile device.

For example, a mobile device may have an application running that monitors the data connection of the mobile device. This application may be a separate application or script, or may be part of a customer care or guide application. The application may determine that the connectivity is faulty due to improperly configured access point names (APNs). Instead of the user attempting to diagnose the source of the problem or call a customer service agent to attempt and diagnose the source of the problem, the mobile device is capable of automatically fixing the problem. Upon determining the APNs are improperly configured, the device may send a predetermined SMS to a remote server at a predetermined number. At the server, the receipt of the SMS triggers a device management action to run on the server, causing the proper APN setting to be identified and then transmitted to the device. Thus, in some examples the system enables a mobile device to recognize a problem at the mobile device, request a solution, and automatically fix the problem without user intervention or without alerting the user.

Referring to FIG. 6, a flow diagram illustrating a routine 600 for triggering a device management action is described. In some cases, routine 600 occurs within step 540 of routine 500. In step 610, the mobile device transmits a message or data to a predefined recipient (such as to a location at a device management server) to trigger an action. The mobile device may transmit a message using SMS, HTTP, USSD, or other communication channels. In some examples, templates for messages that will be transmitted are stored within the device. These templates may be pre-established and stored in a database before configuration problems or updates are encountered by the device or user. This database, such as database 241, may be periodically refreshed or updated, either by the device or a network server. For example, the system may refresh the message template database after performing an action to update the configuration of the device.

In step 620, upon receiving the message sent in block 610, a recipient interprets the message and runs a desired device management action. As described herein, some examples of device management actions include provisioning of new applications, provisioning of application upgrades (such as upgrades required to fix bugs, to fix security flaws, to add new features, and so on), personalization and customization of a mobile device, monitoring a device, repairing a device, and so on. In step 630, the device management server generates a message that includes a desired action to be performed or an indication of a desired action to be performed on the mobile device, and transmits the message to the mobile device. In some examples, the message may include data or other files used by the mobile device in updating settings or other configuration parameters. The message type, contents, parameters and/or protocol is defined by the device management server. For example, the device management server may use an http protocol when transmitting data to the mobile device. In some examples, the message causes the mobile device to update settings or other configuration parameters using data or other files already stored within the mobile device or retrieved by the mobile device from other sources.

In some examples, the system selects one or more actions to be performed based on the received message, the contents of the received message, the destination address of the received message, short codes within the message, and so on. For example, the system may receive a message that includes a certain configuration setting (or, information about the configuration setting), and perform an action related to the setting (such as sending an updated setting to the device).

In some cases, the system may receive a message at a certain destination address and perform an action based on the address of which message is received. For example, the system may receive a message from the mobile device at a certain destination address, and look to a table or other data structure that specifies actions to be performed when messages are received at certain destination addresses. The system can then perform one or more actions based on the received destination address. Furthermore, some or all of the contents of the message may guide the system when selecting an action. When a message is received at the certain destination address, the system can then use the contents of the message (such as information about an identified problem at the mobile device) in order to select one or more actions to perform.

The following is an example use case that illustrates the device-initiated diagnostic and configuration system in some examples. A mobile device includes incorrect MMS (multimedia messaging service) settings. As a result, outbound MMS messages sent from the mobile device do not leave the device's mail outbox successfully, and any inbound MMS messages do not arrive at the device's inbox. A separate diagnostic application running on the mobile device detects the unsuccessful transmission of MMS message from the outbox, and identifies the unsuccessful transmission as a problem with the configuration of the device. (In other examples, the user could report that there is a problem, via the device or via a customer care agent). Using an http connection (or https for increased security), the device transmits a request to the device management server for a repair of the MMS settings. The device retrieves any stored information related to MMS repair from a database within the device, including information used to trigger MMS repair by the system. This information includes the device management server's internet protocol (IP) address and server side script file (e.g., http://70.130.123.101/cgibin/repair_mms.cgi). The mobile device transmits appropriate parameters to implement the repair to the IP address and server side script file related to MMS repair. In this example, the parameters include the device IMEI and phone number, (e.g.,

http://70.130.123.101/cgibin/snapin.cgi?IMEI=353757016523454&SENDTO=120655 56304) and are transmitted using http GET, although http POST can also be used.

At the device management server, the cgi script file receives the message via the http connection and selects the MMS repair actions to be sent to the device. The MMS repair actions include:

Replace “./MMS/MMSAcc/MMRecep”→“Always on”

Replace “./MMS/MMSAcc/Con/DCon/MMSSAddr”→“http://216.155.174/servlets/mms”

Replace “./MMS/MMSAcc/Con/DCon/MToNapID/Primary/MToNapIDL”→“AP/APId003”.

In order to send these actions to the mobile device, the device management server can send a WAP push, or binary SMS, formatted as a Device Management Notification Alert to the device's phone number, causing a client on the mobile device to device to wake up and contact the device management server to receive any awaiting actions or commands. The type of alert is based on protocols established by the Open Mobile Alliance (e.g., http://www.openmobilealliance.org/release_program/docs/CopyrightClick.asp?pck=D M&file=V1_{—}2-20070209-A/OMA-TS-DM_Notification-V1_{—}2-20070209-A. pdf).

For actions that do not need to be sent to the mobile device at any specific time, the system can add the selected actions to a list of actions to be sent to the device during the next device management session between the device management server and the device.

After contacting the device management server, the mobile device receives and processes the MMS repair actions using a device management client within the device that communicates with the device management server over http or https. The device management client is configured with the device management server's contact information, such as the server name, password, IP address, port number, and so on in order to facilitate communications between the device and the server. After receiving and processing the actions, the MMS settings are repaired and the device is able to send and receive MMS messages.

Triggering device management actions via the mobile device may be helpful to a user in a number of ways. Some of the manual techniques are not intuitive to a user, and the user may spend unnecessary effort attempting to solve problems. Additionally, device initiated techniques may alleviate the use of customer service agent assistance in fixing device problems, as the device itself performs steps (such as the recognition of a problem and the triggering of actions to correct the problem typically performed by a customer service agent.

While a single triggering message and repair message are disclosed herein, it will be appreciated that multiple messages exchanging data may be transmitted between the mobile device and the device management server. Such an exchange would allow the device management server to query and receive the results from diagnostics being performed on the mobile device.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

All of the above patents and applications and other references, including any that may be listed in accompanying filing papers, are incorporated by reference. Aspects of the system can be modified, if necessary, to employ the systems, functions, and concepts of the various references described above to provide yet further embodiments of the system.

These and other changes can be made to the system in light of the above Detailed Description. While the above description details certain embodiments of the system and describes the best mode contemplated, no matter how detailed the above appears in text, the system can be practiced in many ways. Details of the local-based support system may vary considerably in its implementation details, while still being encompassed by the system disclosed herein. As noted above, particular terminology used when describing certain features or aspects of the system should not be taken to imply that the terminology is being redefined herein to be restricted to any specific characteristics, features, or aspects of the system with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the system are presented below in certain claim forms, the inventors contemplate the various aspects of the system in any number of claim forms. For example, while only one aspect of the system is recited as embodied in a computer-readable medium, other aspects may likewise be embodied in a computer-readable medium. Accordingly, the inventors reserve the right to add additional claims after filing the application to pursue such additional claim forms for other aspects of the system.

We claim:

1. A method at a server for updating a configuration of a mobile device, the method comprising:
receiving a message from a remote mobile device over a network, wherein the message contains information about a first configuration of the mobile device and a request for an action to be performed with respect to the configuration of the mobile device,
performing the action in response to the received message at the remote location; and
transmitting to the mobile device a second configuration setting over the network, wherein the second configuration setting modifies the configuration of the mobile device.

2. The method of claim 1, wherein the message is received in response to input received from an application running on the mobile device configured to intercept outgoing calls.

3. The method of claim 1, wherein the message is received in response to input received from an application running on the mobile device configured to provide help functions to a user of the mobile device.

4. The method of claim 1, wherein the message is received in response to input received at the mobile device from a user of the mobile device.

5. The method of claim 1, wherein the message is received in response to a query received from a customer service agent related to the mobile device.

6. The method of claim 1, wherein the message is received over a short message channel.

7. The method of claim 1, wherein the message is received over a USSD control channel.

8. The method of claim 1, wherein the message is received via an HTTP protocol.

9. The method of claim 1, wherein the received message includes pre-defined contents originally stored within a database of the mobile device, wherein the pre-defined contents relate to the configuration of the mobile device.

10. A system for automatically adjusting a configuration of a mobile device, comprising:
a script component stored on the mobile device that receives information from an application running on the mobile device that detects an issue associated with the configuration of the mobile device and that communicates with a remote server to trigger an action to be performed on the remote server; and
an action component stored on a remote server that contains one or more actions to be performed related to the detected issue and performs the action upon receiving a communication from the script component;
wherein the performed action causes the configuration of the mobile device to be adjusted.

11. The system of claim 10, wherein the adjusted configuration is a new application stored on the mobile device.

12. The system of claim 10, wherein the adjusted configuration includes additional security settings.

13. The system of claim 10, wherein the adjusted configuration includes settings related to a user of the mobile device.

14. The system of claim 10, wherein the adjusted configuration includes adjusted communications settings.

15. The system of claim 10, wherein the performed action includes transmitting data to the mobile device related to adjusted settings of the mobile device.

16. The system of claim 10, wherein the performed action includes transmitting a new application to the mobile device.

17. A method of configuring a mobile device via a remote server in communication with the mobile device over a network, the method comprising:
receiving a message from the mobile device via a network, wherein the message indicates a first configuration of the mobile device;
selecting an action to be performed from two or more actions to be performed; wherein the action to be performed is selected at least in part on the received message; and
performing the selected action, wherein the performed action provides data to the mobile device related to a second configuration of the mobile device.

18. The method of claim 17, wherein the action to be performed is selected at least in part on contents of the received message.

19. The method of claim 17, wherein the action to be performed is selected at least in part on a destination address of the received message.

20. The method of claim 17, wherein performing the selected action includes transmitting an application to the mobile device.

21. The method of claim 17, wherein performing the selected action includes transmitting a message to the mobile device including information related to the second configuration.

22. A computer readable medium stored within memory of a mobile device whose contents cause a remote server located in a network of the mobile device to perform an action at the remote server, in response to receiving a message transmitted from the mobile device to the remote server, that causes the mobile device to update a configuration setting of the mobile device.

23. The computer readable medium of claim 22, wherein the performed action includes transmitting information related to the configuration setting from the remote server to the mobile device.

24. The computer readable medium of claim 22, wherein the received message includes contents related to the performed action.
